(19) United States
(12) Patent Application Publication
(10) Pub. No.: US 2018/0235157 A1
(43) Pub. Date: Aug. 23, 2018

(54) Portable, adjustable, garden shade and weather protection panels

(71) Applicant: Sherri Leslie, Leander, TX (US)

(72) Inventor: Sherri Leslie, Leander, TX (US)

(21) Appl. No.: 15/932,348

(22) Filed: Feb. 20, 2018

Related U.S. Application Data
(60) Provisional application No. 62/600,401, filed on Feb. 21, 2017.

(51) Int. Cl. A01G 13/02

(52) U.S. Cl. CPC A01G 13/0206; A01G 13/0225

(57) ABSTRACT

A unit providing garden plant protection from harmful weather conditions and extend the growing season. The unit includes a shade cloth attached to a frame creating a panel that attaches to at least two post, which are attached at opposite ends of the panel for support. Each post has a ground stake attached to the bottom end. The ground stakes allow for easily placing and securing the unit in desired locations and can easily be removed from the ground. The panel can be adjusted to different angles depending on weather protection needs. The post can be raised or lowered as needed. The posts can be detached from the panel for a simplified storage solution.

### CROSS-REFERENCES TO RELATED APPLICATIONS

This applications claims priority to Provisional Patent Application No. 62/600,401, entitled “Portable, Adjustable, Shade and Weather Protection Panels,” filed Feb. 21, 2017, of which the full disclosure of the application is incorporated herein by reference for all purposes.

### BACKGROUND OF THE INVENTION

### 1. Field of the Invention

This invention relates to gardening. Specifically, portable, adjustable, panels that provide plants protection from harmful weather conditions.

### 2. Brief Description of the Related Art

As many people have become more health conscience and clean eating is increasingly popular, so has having a backyard garden. Growing your own food has many benefits as you control what is being used in the garden. However, you can not control the weather which can be damaging to an unprotected garden. Conditions such as high winds, heavy rain, and hail can occur with short notice requiring prompt protection to prevent costly damage to a garden. Additionally, a late spring frost or freeze can kill a garden early on, and a early fall frost or freeze can shorten the growing season if unprotected. Furthermore, the longer days of summer can require shading a garden from too much direct sunlight and high temperatures.

A variety of garden protection items used to protect from weather conditions are well known, such as shade fabric, floating row covers, frost blankets, cloches, pots or buckets, hoop houses, and cold frames. As for the shade cloth, floating row covers, hoop houses, and frost blankets, all require anchoring whether tying to something, using multiple stakes or pins, or heavy objects to keep them in place, none of which can be easily accomplished on very short notice or attempting in windy conditions as they can blow into plants causing further damage. The use of pots or buckets to protect from frost or freeze also require weighting down with heavy items such as rocks or bricks, and is time consuming placing one over each plant. Cloches can be small for individual plants in which the plants quickly outgrow so are only good for a short time and they must be removed before sunlight raises the temperature inside to damaging levels. Large cloches for several plants also need to be removed if they are not vented, they are bulky, usually hard plastic and take up ample space to store. Cold frames wrap around plants and are filled with water, which is again time consuming to place and remove. Each of the items are for individual weather conditions, it would require having a combination of such to achieve protection from all weather conditions which requires ample storage space, can be very costly for such variety, and as mentioned, none are quick to put in place or to remove.

Therefore it can be appreciated that there exist a need for garden protection from a variety of weather conditions that is quick and simple to place or remove, multi purposeful, economical, and conveniently stored. It is an object of the present invention to provide such apparatus.

### SUMMARY OF THE INVENTION

An object of the present invention is to provide garden protection panels which can be quickly and easily placed in any desired location for temporary or longer term use, to shield a garden from costly damaging weather conditions that is also economical and requires minimal storage space.

In order to achieve the disadvantages of the preceding objects, portable adjustable garden shade and weather protection panels comprising shade fabric attached to a tubular frame creating a panel. The panel is attached to adjustable tubular posts that may be raised or lowed as needed. Stakes are attached to the bottom of each post for quick and simple placement. The panel can be adjusted at an angle, horizontal, or vertical to achieve protection from a variety of weather condition. The tubular posts can be removed from the panel for easy storing.

### BRIEF DESCRIPTION OF THE DRAWING

The detail structure, the applied principle, the function and the effectiveness of the present invention can be more fully understood with reference to the following description and accompanying drawings, in which:

FIG. 1 is a perspective illustration of the embodiment of the present invention.

FIG. 2 is a perspective view of the embodiment of the of the present invention shown in FIG. 1 positioned horizontally.

FIG. 3 is a perspective view of the embodiment of the present invention shown in FIG. 1 positioned vertically.

FIG. 4 is a perspective view of the embodiment of the present invention shown in FIG. 1 positioned at an angle.

### DETAILED DESCRIPTION OF THE INVENTION

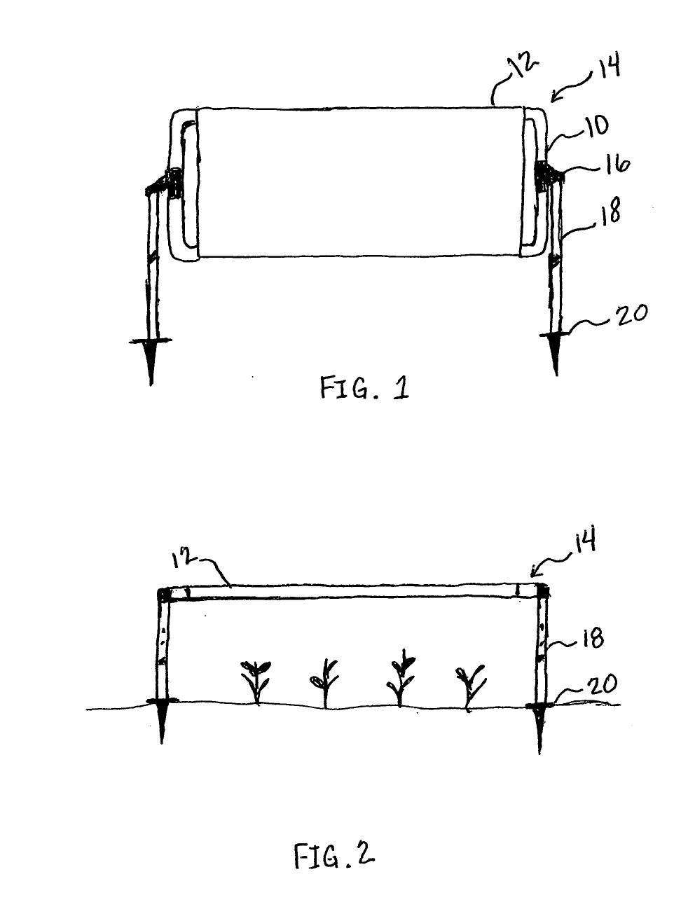

Referring to FIG. 1 Shade fabric 12 is attached to a tubular frame 10 creating a panel 14 which is then attached to a connector 16 that holds the panel 14 in a desired position, the angle of the panel 14 may be adjusted as needed by twist and lock, snap pins, among other adjusting sources. Extendable tubular poles 18 which may be extended or recessed for desired height adjustments are connected to the connector 16 at one end and ground stakes 20 connect to the bottom the extendable tubular post 18. The ground stakes 20 are simply pressed into the ground to secure placement of the embodiment of the present invention.

Referring to FIG. 2 The extendable post 18 are recessed in which the lowered height is ideal for smaller plants and the panel 14 is in horizontal position which is the desired position to protect plants from too much direct sun as the shade fabric 12 provides shade and reduces temperature below, this position also is used to protect plants from a heavy rain as is reduces the impact of a damaging downpour, also this position is used when needed to block direct impact of hail from damaging plants, additionally while the present invention alone does not protect plants from a frost or freeze in this position it provides support to keep the weight of a freeze covering of choice off the plants.

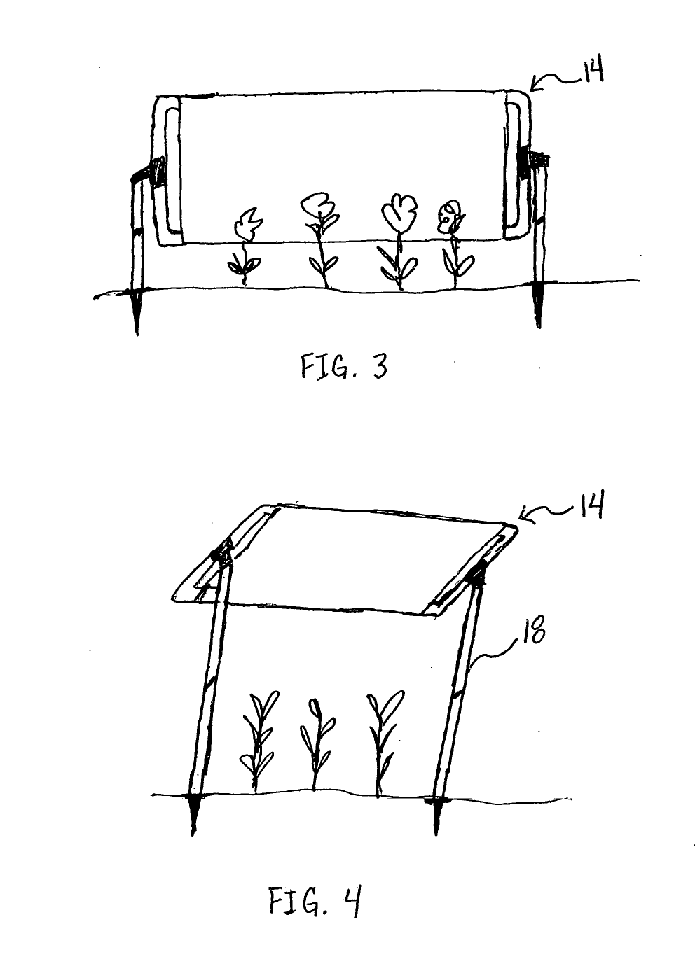

Referring to FIG. 3 the panel 14 is adjusted to a vertical position which is ideal to reduce the impact of wind, also to protect from too much afternoon sun by providing shade and reduced temperature to the plants.

Referring to FIG. 4 the extendable post 18 are shown extended as the raised height is needed as plants get taller. The extendable post 18 may be telescoping by snap pins, twist lock, or other means for raising and lower the post. The panel 14 is adjusted at an angle to control direct sunlight as desired.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the appended claims.

What is claimed is:

1. A portable, adjustable, garden shade and weather protection panel unit to protect garden plants from damaging weather conditions and extend the growing season comprising, in combination:
a shade cloth that tightly fits to a tubular frame creating a panel;
a connector that fits to the frame and to the tubular post;
a pair of tubular posts that fit to the connectors that attach to the panel frame on opposite ends;
a ground stake attached to the end of each post.

2. The portable, adjustable, garden shade and weather protection panel unit as set forth in claim 1, wherein the panel can be adjusted to various angles.

3. The portable, adjustable, garden shade and weather protection panel unit as set forth in claim 2, and further including extendable post that can be extended or recessed.

4. The portable, adjustable, garden shade and weather protection panel unit as set forth in claim 3, wherein the post can be detached in order to minimize storage space needed.
